(19) United States
(12) Patent Application Publication
(10) Pub. No.: US 2025/0246661 A1
(43) Pub. Date: Jul. 31, 2025

(54) VOLTAGE GENERATOR BASED ON A MATERIAL COMPRISING GLYCOSYLATED PROTEINS AND AMYLOID FIBRES

(71) Applicants: COMMISSARIAT A L'ENERGIE ATOMIQUE ET AUX ENERGIES ALTERNATIVES, Paris (FR); UNIVERSITE GRENOBLE ALPES, Saint-Martin-D'Hères (FR); CENTRE NATIONAL DE LA RECHERCHE SCIENTIFIQUE, Paris Cedex 16 (FR); IFREMER - INSTITUT FRANCAIS DE RECHERCHE POUR L'EXPLOITATION DE LA MER, Plouzane (FR)

(72) Inventors: Vincent FORGE, Grenoble Cedex (FR); Joffrey CHAMPAVERT, Grenoble Cedex (FR); Julien HURTAUD, Grenoble Cedex (FR); Herlé GORAGUER, Saint-Pierre et Miquelon (FR); Adina MOROZAN, Grenoble Cedex (FR)

(73) Assignees: COMMISSARIAT A L'ENERGIE ATOMIQUE ET AUX ENERGIES ALTERNATIVES, Paris (FR); UNIVERSITE GRENOBLE ALPES, Saint-Martin-D'Hères (FR); CENTRE NATIONAL DE LA RECHERCHE SCIENTIFIQUE, Paris Cedex 16 (FR); IFREMER - INSTITUT FRANCAIS DE RECHERCHE POUR L'EXPLOITATION DE LA MER, Plouzane (FR)

(21) Appl. No.: 18/855,845

(22) PCT Filed: May 3, 2023
(86) PCT No.: PCT/EP2023/061701

§ 371 Date: Oct. 10, 2024

(30) Foreign Application Priority Data
May 3, 2022 (FR) FR2204203

(51) Int. Cl. H01M 8/16

(52) U.S. Cl. CPC H01M 8/16

(57) ABSTRACT

A method for electrochemically activating a material comprising hydronium ion-conducting amyloid fibers and glycosylated proteins, in which the method includes placing at least part of the material in contact with a water vapor, electrolyzing at least part of the water vapor which is in contact with the material, and obtaining an activated material. The invention also relates to an activated material obtained in this way and to it use for generating electrical energy.

### TECHNICAL FIELD

The present invention relates to a voltage generator. More precisely, the invention describes a material, activated by an electrochemical process, which comprises glycosylated proteins and amyloid fibers and enables the production of electrical energy from ambient humidity or from any atmosphere containing water vapor. The invention also describes the use of such a material for producing electrical energy and the process for preparing it.

### PRIOR ART

The demand for energy, in particular for electrical energy, is continuously increasing, and it is becoming necessary to have available renewable energy sources in order to reduce the negative environmental impacts associated with the consumption of fossil energy. Water, covering 71% of the Earth's surface, is the world's largest reservoir of energy. Water captures around 35% of the solar energy received by the Earth, corresponding to 60 petawatts (1015 W) (Stephens et al., Nature Geosci 5, 691-696 (2012)).

Many efforts have been made with a view to recovering the energy from water in various forms: rivers and oceans, tides or also raindrops. The recovery of energy from water, hydroelectricity, is mainly done with the construction of hydraulic dams or tidal plants. These plants mainly use electromagnetic generators which are heavy and bulky and are dependent on the available water supply.

Very recently, hydrovoltaics has been proposed as an alternative means of producing electrical energy from water (Zhang et al., Nature Nanotech 13, 1109-1119 (2018)). Unlike current technologies that recover kinetic energy (in the case of streams and rivers) or potential energy (in the case of basins and lakes) from water, hydrovoltaic technology makes it possible to generate energy directly from the direct interaction between water and material. However, the hydrovoltaics developed to date mainly uses inorganic materials. The materials currently used are made from nanowires of silicon, Ni/Al hydroxide or else from carbon (graphene or carbon nanotubes) (Yang et al. (2018) J. Am. Chem. Soc. 140, 13746-13752; Tang et al., (2016), Angew. Chem. Int. Ed. 55, 14412-14416; Yin et al., (2014), Nat. Commun. 5, 3582; Xu et al., Nature 578, 392-396 (2020))

Water in the form of vapor in the ambient atmosphere might also be used for recovering energy.

The production of electrical energy from ambient humidity with biological materials has been reported (Liu et al., Nature 578, 550-554 (2020); WO 2020/069523).

However, this device, composed of bionanowires obtained from Geobacter sulfurreducens, must be exposed to a water vapor gradient in order to produce energy. These filaments do not result from a spontaneous self-assembly, but require the internal machinery of the bacterium for their formation. Moreover, the bionanowires used are obtained from a recombinant protein requiring the use of Escherichia coli as a support for their production; this is a significant blocker to mass production and large-scale industrialization of the process.

Fish of the family Myxinidae are anguilliform aquatic animals having no vertebral column and no true jaw. These animals produce a violently expanding mucus, or hydrogel, that clogs the gills of any predator attempting to eat them, which in response will immediately spit them out. This mucus is formed from dry fibers of mucins, glycosylated proteins, which instantly hydrate into a mucus and from fibrous threads rich in intermediate filaments (IFs). The fibrous elements are only 12 nanometers thick and measure up to 15 centimeters long. Under the action of mechanical stress, for example stretching, the proteins of the intermediate filament fibers can undergo a transition from a helices to β sheets, leading to the formation of amyloid fibers (Böni et al., Sci Rep. 2016; 6:30371; Fu et al., Biomacromolecules. 2015; 16(8):2327-2339; Fudge et al., Biophys. J. 2003; 85 (3):2015-2027).

The particular properties of the hydrogel of the Myxinidae are of interest to many companies that wish to take advantage of it.

For example, the company Benthic Labs is developing a biodegradable polymer manufactured from components of the mucus, which could be used in the manufacture of fabrics for protective clothing, food packaging, elastic cords, bandages or airbags.

There is a need for a material which makes it possible to generate electrical energy from a humid surrounding atmosphere, which is of low cost and which can be easily obtained, in particular on an industrial scale.

There is also a need for such a material that is biodegradable and renewable.

There is also a need for such a material that makes it possible to produce an amount of electrical energy that is adjustable as a function of the relative humidity in the surrounding atmosphere.

There is also a need for such a material that enables the production of different electrical configurations.

There is also a need for a material capable of supplying electrical energy to various electrical or electronic apparatuses by generating electrical energy from a humid surrounding atmosphere.

An objective of the present invention is to satisfy all or some of these needs.

### SUMMARY OF THE INVENTION

According to one of its subjects, the present invention relates to a process for preparing a material activated by electrochemical activation, said material comprising hydronium ion-conducting amyloid fibers and glycosylated proteins, said process comprising at least the steps consisting in:
(a) bringing at least a part of said material into contact with water vapor,
(b) electrolyzing at least some of the water vapor in contact with said material, and
(c) obtaining an activated material.

For the purposes of the invention, the term “electrochemical activation” is intended to qualify a process comprising a step in which a material is exposed to an electric current in order to modify the chemical structure of this material, the material being suitable for such a process, and making it possible to confer upon this material the property of generating electrical energy from the water vapor of the surrounding atmosphere. A material obtained from an electrochemical activation process described herein is referred to in the present description as an “activated material”.

For the purposes of the invention, the expression “activated material” is intended to denote a material resulting from an electrochemical activation process by which the structure of the material is modified to confer upon it voltage-generating properties. An activated material is a material capable of producing electrical energy when it is brought into contact with water vapor of a humid surrounding atmosphere, by conduction of hydronium ions.

The electrochemical activation of a material described herein can, for example, be monitored by chronoamperometry. This method makes it possible to measure the quantity of electric charges circulating in the material during its electrochemical activation. The activation can be verified by the generation of an open-circuit electrical potential difference when the material is exposed to a humid atmosphere.

For the purposes of the invention, the expressions “humid atmosphere” or “humid surrounding atmosphere” are intended to denote an atmosphere comprising water molecules in the vapor state. The water vapor content of a humid atmosphere suitable for the invention can range from about 30% to about 100%, or from about 35% to about 99%, or from about 40% to about 95%, or from about 45% to about 90%, or from about 50% to about 85%. A humid surrounding atmosphere is an atmosphere in contact with a material as described herein.

The term “generating electrical energy from a humid surrounding atmosphere” is understood to denote, for the purposes of the invention, the capacity of an activated material, as described herein, to react with at least some of the water vapor, or humidity, contained in the surrounding (i.e. in contact therewith) atmosphere and generate electrical energy. The water vapor content of such an atmosphere is sufficient to allow the generation of hydronium ions. The hydronium ions can circulate within the structure of the activated material. A sufficient water vapor content can range from about 30% to about 100%.

The term “electrical energy” is understood to denote the potential energy of an electric charge in an electric field or an electric current in a magnetic field. The electrical energy generated during the use, according to the invention, of an activated material is an electrical potential difference that is created between two ends of the material. This electrical potential difference can be used to generate an electric current.

According to another of its subjects, the present invention relates to an activated material comprising hydronium ion-conducting amyloid fibers and glycosylated proteins and being activated by an electrochemical activation process.

According to another of its subjects, the present invention relates to an activated material obtained by a process described herein, said material comprising hydronium ion-conducting amyloid fibers and glycosylated proteins.

Unexpectedly, as detailed in the examples below, the inventors have observed that it was possible to confer upon a material comprising hydronium ion-conducting amyloid fibers and glycosylated proteins, for example in the form, respectively, of intermediate filaments and mucins, for example prepared by dehydration of a hagfish hydrogel or mucus, properties rendering it capable of generating an electric current from ambient humidity, or ambient water vapor. Advantageously, such a material is 100% biological and is renewable. It makes it possible to obtain an electrical potential difference from the surrounding humid atmosphere and thus produce low-cost green energy depending on the ambient humidity.

Advantageously, in comparison with inorganic materials, an activated material is biodegradable, non-toxic, and biocompatible.

According to another of its advantages, an activated material described herein makes it possible to obtain an electrical potential difference at ambient humidity and at very high humidity (for example of 40% to 85%), thus making it possible to adjust the voltage obtained and modulate it to a target value.

According to another of its advantages, an activated material described herein can have a high internal resistance (˜50 kΩ). In a device for generating electrical energy, comprising an activated material described herein, the resistance may be adjustable to order by varying the amount of material, for example in the form of films which can be placed in series or in parallel.

According to another of its advantages, an activated material described herein can have a high stability.

According to another of its advantages, an activated material described herein naturally possesses adhesion properties which can be exploited in order to simply prepare, at low cost, devices for producing electrical energy. For example, a material in film configuration may be cut into pieces, the pieces then being wetted and bonded to and between electrodes.

An activated and dried material can be used in various textile production processes to prepare textile fibers and fabrics. The fibers and fabrics thus obtained can be used in devices that generate electricity from the surrounding humidity. For example, an activated material described herein can be dried and carded, and the fibers obtained can then be spun. The threads of fibers of activated material thus obtained may advantageously be woven by any techniques for forming the textile in order to manufacture woven or nonwoven fabrics. The combination of the fibers or threads of an activated material with fibers or threads of a second electrically conductive material, for example carbon fibers, can make it possible to manufacture, by weaving techniques, devices that generate electricity from water vapor over large areas.

In an electrochemical activation process described herein, the step (b) of electrolysis of the water vapor in contact with a material to be activated can be carried out by exposing the material to an electrical potential difference.

An electrical potential difference can be obtained by means of two electrodes electrically connected to the material.

An electrical potential difference suitable for the invention is an electrical potential difference capable of inducing electrolysis of at least some of the water vapor.

The electrical potential difference may be fixed or variable.

For the purposes of the invention, the term “fixed” describes an electrical potential difference which remains substantially constant during the period of time necessary for electrochemical activation of a material such as described herein.

For the purposes of the invention, the term “variable” describes an electrical potential difference which changes during the period of time necessary for the electrochemical activation of a material such as described herein and which for a sufficient period of time retains a value enabling the electrolysis of the water.

An electrical potential difference may be at least 1.23 V.

In step (b), an electrical potential difference is applied for a period of time for a duration sufficient to achieve the generation of an electric current in the material. The generation of such an electric current may be measurable via chronoamperometry at 0 V vs E_{oc} (open-circuit electrical potential).

The water vapor used in a process described herein can originate from a humid atmosphere surrounding the material.

A humid surrounding atmosphere suitable for an electrochemical activation process described herein can comprise a relative humidity ranging from at least 60% to 100%, and in particular can range from about 65% to about 85%.

The surrounding atmosphere can be a humid and neutral atmosphere.

The water vapor used in a process described herein can originate from a humid and neutral atmosphere.

For the purposes of the invention, the expression “neutral atmosphere” is intended to denote a chemically neutral atmosphere, that is to say an atmosphere which does not react with the elements in contact with it, such as the material to be activated or the electrodes. A neutral atmosphere is an atmosphere devoid of oxygen.

A neutral atmosphere may be a nitrogen or argon atmosphere, and for example is a nitrogen atmosphere.

In a material of the invention, the hydronium ion-conducting amyloid fibers may be obtained from intermediate filaments. The intermediate filaments are capable of adopting the conformation of amyloid fibers after exposure to mechanical stress, such as stretching. Thus, the hydronium ion-conducting amyloid fibers may be obtained from stretched intermediate filaments.

The intermediate filaments may be composed of proteins selected from α-keratin, lamin, vimentin, desmin, peripherin, syncoilin, α-internexin, neurofilament, synemin, α, β and γ thread keratins, variants of these proteins, and mixtures thereof.

A protein variant, or protein isoform, is a member of a set of highly similar proteins that originate from a single gene or a single gene family and are the result of genetic differences. Variants of a protein family generally have similar biological functions.

The intermediate filaments may be combined, or organized, into fibers or threads.

The glycosylated proteins may be mucins, in particular mucins capable of forming a mucus in the presence of water.

According to one embodiment, a material comprising hydronium ion-conducting amyloid fibers and glycosylated proteins may be obtained from a hydrogel produced by a fish selected from fish of the family Myxinidae, and in particular from the subfamilies Myxininae and Eptatretinae.

According to one embodiment, a material suitable for the invention may be obtained from a hydrogel produced by a fish selected from fish of the genus Myxine or Eptatretus.

According to one embodiment, a material suitable for the invention may be obtained from a hydrogel produced by Myxine glutinosa.

The intermediate filaments of a hydrogel produced by a fish of the family Myxinidae may be subjected to a step of stretching in order to transform at least some of the a helices of the intermediate filament proteins into β sheets and confer upon the intermediate filaments, at least partially, a structure and properties of amyloid fibers. These amyloid fibers are in particular conductors of hydronium ions.

The material used in a process as described herein may be dehydrated.

A dehydrated, or dried, material is a material the water content of which has been reduced by drying. The water content of a dehydrated material may be reduced by at least 10% to at least 99% of the initial water content. The amount of water removed in a dehydrated material can be measured, for example, by measuring the mass of the material before and after drying, the difference in mass representing the amount of water removed. The residual water content in the dehydrated material can be measured, for example, by near infrared spectroscopy.

A material used in the invention may be used in the form of a fiber, a thread or a film. The forming of the material may be effected before or after its activation by a process of the invention.

The term “fiber” is understood to denote a structure the longitudinal dimension of which is significantly greater than the lateral dimension. The term “thread” is understood to denote an assembly of fibers. The term “film” is understood to denote a structure the longitudinal and lateral dimensions of which are significantly greater than the transverse dimension. A film may be composed of a set of fibers or threads.

An activated material is a conductor of hydronium ions.

The term “hydronium ion” is understood to denote the H₃O⁺ cation resulting from

the protonation of a molecule of water.

The term “hydronium ion-conducting” material is understood to denote the capacity of a material to provide for conduction of ionic and protonic type enabling the transfer of hydronium ions or protons.

An activated material as described herein may comprise at least one additional

electrically conductive material.

An additional electrically conductive material may be a carbon fiber, a metal fiber, conjugated polymers, or nanoparticles.

An activated material as described may be configured in the form of a woven or nonwoven textile.

According to one of its aspects, the present invention relates to the use of an activated material as defined herein, in particular obtained by a process as defined herein, for generating electrical energy from a humid surrounding atmosphere.

The material thus used may be electrically connected to a first electrode and to a second electrode. The first and/or second electrodes may be selected from gold, silver, platinum, aluminum or carbon electrodes.

According to another of its aspects, the present invention relates to a device for producing electrical energy, comprising:
(a) at least one activated material as defined herein, in particular obtained by a process as defined herein,
(b) at least one pair of electrodes comprising a first electrode and a second electrode, said electrodes being electrically connected to said material,

said material being intended, or configured, to be exposed, at least partially, to a humid surrounding atmosphere.

A device for producing energy as described herein is configured to provide for the exposure of at least a part of the activated material as described herein to a humid surrounding atmosphere.

According to another of its aspects, the present invention relates to the use of a device for producing energy as described herein for supplying electrical energy to an electrical or electronic apparatus intended, or configured, to be supplied with electrical energy.

According to another of its aspects, the present invention relates to a process for supplying electrical energy to an electrical or electronic apparatus intended to be supplied with electrical energy, the process comprising at least a step consisting in exposing, to a humid surrounding atmosphere, at least partially, at least one activated material as defined herein, in particular obtained by a process as defined herein, said material being arranged in a device for producing electrical energy as described herein, said device being electrically connected to said electrical apparatus.

According to another of its aspects, the present invention relates to a process for supplying electrical energy to an electrical or electronic apparatus intended, or configured, to be supplied with electrical energy, the process comprising at least the steps consisting in:
a) electrically connecting a device, as described herein, to an electrical or electronic apparatus intended to be supplied with electrical energy, and
b) exposing, at least partially, said material to a humid surrounding atmosphere.

According to another of its aspects, the present invention relates to a process for manufacturing a device as described herein, in particular obtained by a process as defined herein, comprising at least a step consisting in electrically connecting an activated material as described herein to a first electrode and to a second electrode of a pair of electrodes.

According to another of its aspects, the present invention relates to an electrical or electronic apparatus supplied with electrical energy by a device as described herein.

According to another of its aspects, the present invention relates to a humidity sensor comprising at least one device as described herein.

According to another of its aspects, the present invention relates to a humidity-responsive electrical circuit breaker comprising at least one device as described herein.

According to another of its aspects, the present invention relates to an electrical charger comprising at least one device as described herein.

These subjects, features and advantages and also other aspects of the present invention will be explained in detail in the following description.

### BRIEF DESCRIPTION OF THE DRAWINGS

FIG. 1 represents (A) a diagram of the device for the electrochemical activation of a film of amyloid fibers and glycosylated proteins that is composed of mucins and intermediate filament proteins (mucin film) and obtained by dehydration of a hydrogel secreted by a hagfish, the mucin film being electrically connected to two electrodes connected to a source of electrical energy, and the assembly being disposed on a support; and (B) a diagram of the chamber comprising the device, the chamber being a three-neck round-bottom flask sealed by hermetic stoppers making it possible to ensure the electrical connection of the electrodes and the establishment of a neutral atmosphere (N₂) of the device, the water vapor of the atmosphere being obtained with a saturated KCl solution. The electronic characterizations of the mucin films were carried out with a Biologic SP-200 potentiostat equipped with a low-current probe. Humidity control was effected with a saturated KCl solution and a Sensirion humidity sensor.

FIG. 2 represents (A) the I-V curves between 0 V and 3 V at 5 mV/s under nitrogen (N₂) and 85% relative humidity (RH) just after degassing (dashed line) and after 2 h at 3 V vs E_{ref} (dotted line); (B) the chronoamperometry curves at 3 V vs E_{ref} on the mucin film at 85% RH and under N₂: (continuous line) applied voltage, (dashed line) measured current; and (C) the chronoamperometry curves at 0 V vs E_{OC} on the mucin film at 85% RH and under N₂: (continuous line) measured voltage (E_{OC}), (dashed line) measured current. The value of E_{OC} during the degassing is also shown.

FIG. 3 represents (A) the evolution of the open-circuit voltage across the terminals of the mucin film before charging the capacitor and influence of the direction of connection on the electrodes demonstrating polarization of the mucin film; and (B) the charging of a capacitor of capacitance 470 μF and voltage 16 V.

FIG. 4 represents (A) a typical power curve obtained for an electrochemically activated hagfish mucus film and (B) a curve of discharge into a 31 kilohm resistor which corresponds to the load making it possible to deliver the maximum power.

### DETAILED DESCRIPTION

### Definitions

Unless defined otherwise in the description, the scientific and technical terms used in connection with the present invention have the meanings which are commonly understood in the technical field. In the event of a conflict, the present description shall prevail. Units, prefixes and symbols are indicated in their accepted form of the International System of Units (SI). The titles provided in the document description are not limiting for the various aspects of the disclosure. The list of sources, ingredients and components described below is enumerated such that combinations and mixtures thereof are also considered and fall within the scope of application of the present document. Examples of processes and materials are described below, and processes and materials similar or equivalent to those described herein may also be used in the implementation of the present invention. It is appreciated that certain features of the invention, which are, for greater clarity, described in the context of distinct embodiments, may also be provided in combination in a single embodiment. Conversely, various features of the invention, which are described in the context of a single embodiment for the sake of brevity, may also be provided separately or in any appropriate sub-combination.

Numerical ranges include all numbers that define the range. Each maximum numerical limit given throughout the description includes any lower numerical limit, just as if these lower numerical limits had been expressly written. Each minimum numerical limit given throughout the description includes any greater numerical limit, just as if these higher numerical limits had been expressly written in the present document. Each numerical range given throughout the description includes any narrower numerical range that falls within such a broad numerical range, just as if these narrower numerical ranges had all been expressly written herein.

All lists of articles, such as, for example, lists of ingredients, are intended to and should be interpreted as Markush groups. Thus, all lists can be read and interpreted as elements “selected from the group consisting of the list of articles” and combinations and mixtures thereof.

Reference may be made in the present document to the trade names of components, including various ingredients used in the present disclosure. The inventors do not have the intention of being limited by materials under a particular trade name. Materials equivalent (e.g., those obtained from a different source under a different reference number or name) to those mentioned by trade name may be substituted and used in the descriptions below.

All publications and other references mentioned in the description are incorporated by reference in their entirety.

Unless the context indicates otherwise, terms indicated in the singular include the plural and terms in the plural include the singular. The terms “a/an/one”, “one or more” and “at least a/an/one” may be used interchangeably in the description.

In the description, the embodiments described herein with the terms “having” or “comprising” include the embodiments described with the terms “comprising only”, “consisting of” and/or “consisting essentially of”. The expression “consisting of” implies the inclusion of the stated elements to the exclusion of any other element. The expression “consisting essentially of” implies the inclusion of the stated elements and possibly other elements where the other elements do not significantly affect the fundamental feature(s) of the disclosure.

In addition, the expression “and/or” should be considered as a specific disclosure of each of the two features with or without the other. Thus, the expression “and/or” used in an expression such as “A and/or B” is intended to include “A and B”, “A or B”, “A” (alone) and “B” (alone).

The terms “about” or “approximately” signify an acceptable measurement error for a particular value of a parameter determined by the usual measurement methods in the field and which will depend in part on the way in which the value is measured or determined, that is to say on the limits of the measurement system. For example, “about” may mean within a range of three or more than three standard deviations, according to the practice in the art. Alternatively, “about” may mean a numerical range or deviation ranging up to 20%, for example up to 10%, for example up to 5%, or also up to 1% of a given value.

The expression “significantly” used with respect to a change or difference is intended to mean that the observed change or difference is perceptible and/or that it is statistically significant.

In the description, the terms “substantially” or “substantially identical” used in conjunction with a feature are intended to define a set of embodiments related to that feature that are largely, but not entirely, similar to that feature.

### Material Comprising Hydronium Ion-Conducting Amyloid Fibers and Glycosylated Proteins

A material suitable for an electrochemical activation process of the invention is a material comprising amyloid fibers and glycosylated proteins and being capable of being activated according to a process as described herein. Such a material is said to be “electroactivatable” or “activatable by an electrochemical activation process”.

### Amyloid Fibers

The term “amyloid fiber” is understood to denote a fiber comprising proteins which are structured in β sheets and are organized into fibers. The fiber may consist entirely of proteins structured in β sheets, or may consist essentially of proteins structured in β sheets, i.e. in an amount sufficient to confer upon the fiber the properties of an amyloid fiber.

Amyloid fibers suitable for the invention are hydronium ion conductors.

According to one embodiment, the amyloid fibers may be prepared from intermediate filaments.

For the purposes of the invention, the expression “intermediate filament” is intended to denote an assembly of proteins combined into filaments of about 10 nm in diameter and making up the structure of the cytoskeleton of numerous cells in most metazoan taxa or of the defensive mucus produced by the Myxinidae.

Intermediate filaments (IFs) consist of a set of proteins organized into filaments of about 10 to 12 nm in diameter and several micrometers in length and constitute a component of the cytoskeleton in most metazoan taxa or of the defensive mucus produced by the Myxinidae.

Intermediate filaments share a common architecture characterized by a coiled-coil a-helical central domain flanked by a largely amorphous N-terminal “head” domain and a C-terminal “tail” domain of variable length and sequence. On account of their open molecular architecture and their single assembly plane, intermediate filaments possess mechanical properties combining extreme extensibility, flexibility and toughness (Böni et al., ACS Appl Mater Interfaces. 2018; 10(47): 40460-40473), as well as a very strong hydration property.

Intermediate filaments are composed of proteins rich in a helices capable of being converted into β sheets when the proteins are subjected to mechanical deformations such as stretching (Litvinov et al., Biophys J. 2012; 103(5): 1020-1027).

An intermediate filament suitable for the invention is a filament comprising a helical domains of a length of at least greater than 3.8 nm.

According to one embodiment, the amyloid fibers are stretched intermediate filaments. A “stretched intermediate filament” is a filament which has undergone sufficient mechanical deformation to convert all or some of the a helices of the proteins constituting the intermediate filaments into β sheets. The conversion of the a helices into β sheets can be measured or monitored by FTIR spectroscopy (Fourier transform infrared spectroscopy) or by colorimetry using the dye Congo Red (Litvinov et al., Biophys J. 2012; 103(5): 1020-1027;Fudge et al., Biophys J. 2003; 85(3):2015-2027).

By way of examples of intermediate filaments suitable for the invention, mention may be made of intermediate filaments composed of proteins selected from α-keratin, lamin, vimentin, desmin, peripherin, syncoilin, α-internexin, neurofilament, synemin, α, β and γ thread keratins, for example obtained from the defensive mucus produced by the Myxinidae, variants of these proteins, and mixtures thereof.

According to one embodiment, the intermediate filaments suitable for the invention may be composed of α, β and γ thread keratin proteins, and mixtures thereof. The α, β and γ thread keratin proteins, and mixtures thereof, may originate from the defensive mucus produced by the Myxinidae.

The intermediate filaments may be combined together into fibers or threads.

The intermediate filament fibers or threads may have a diameter ranging from about 0.5 to about 5 μm, or from about 1 to about 3 μm, or from about 1.5 to about 2 μm.

The intermediate filament fibers or threads may have a length ranging from about 1 to about 20 cm, or from about 2 to about 18 cm, or from about 5 to about 15 cm.

The intermediate filaments may be extracted from natural sources or be produced recombinantly in fermenters using recombinant microorganisms genetically modified to produce the proteins making up the intermediate filaments.

By way of example, intermediate filaments can be obtained recombinantly according to the process described by Oliveira et al. (Microb Biotechnol. 2021; 14 (5): 1976-1989) or in applications US 2019/0002529 A1, or US 2005/0034280 A1.

By way of example, intermediate filaments can be prepared from the mucus or hydrogel produced by fish of the family Myxinidae, such as the hagfish. The hagfish threads consist of axially aligned intermediate filaments which condense into a solid fiber with a diameter of about 1 to 3 μm which can measure up to about 15 cm in length (Böcker et al., ACS Biomater. Sci. Eng., vol. 2, no. 1, pp. 90-95, 2016).

When a hagfish is attacked by a predator, it will release, via glands, dry fibers of mucin and intermediate filaments. These fibers instantaneously hydrate to give a mucus and fibrous threads rich in intermediate filaments (IFs) (Böcker et al., ACS Biomater. Sci. Eng., vol. 2, no. 1, pp. 90-95, 2016).

The hagfish intermediate filaments comprise three thread keratin (TK) proteins (α, β and γ). Hagfish intermediate filaments are described as “keratins” because of characteristics in the head and tail domains that are similar to keratin. TKα is a homologue of type II keratin and TKγ possesses characteristics of type I keratins, but also contains structural similarities with type III intermediate filaments, which include desmin and vimentin (Böni et al., ACS Appl Mater Interfaces. 2018; 10(47):40460-40473).

The intermediate filaments of a hydrogel of a fish of the family Myxinidae can be configured into amyloid fibers by exposing the hydrogel to mechanical deformation, such as stretching. This deformation may be applied during the manipulation, for example manual manipulation, of the hydrogel when it is recovered from the fish or by any mechanical device enabling such stretching. Alternatively, the mechanical deformation, for example stretching, may be exerted on the intermediate filaments of a dry material.

### Glycosylated Proteins

According to one embodiment, a material suitable for the invention comprises glycosylated proteins.

A glycosylated protein is a protein onto which sugar (or glycosyl) groups have been grafted. The attachment can be effected on nitrogen atoms—N-glycosylation—or on oxygen atoms—O-glycosylation. Glycosylated proteins suitable for the invention are capable of forming a mucus in the presence of water.

Glycosylated proteins suitable for the invention are glycosylated proteins capable of forming a hydrogel in the presence of an aqueous phase.

The term “hydrogel” is understood to mean a system which comprises networks of chemically or physically bonded polymers and traps water in the intermolecular spaces. Glycosylated proteins capable of forming hydrogels are known to those skilled in the art.

Glycosylated proteins that are suitable for the invention may be mucins.

For the purposes of the invention, the term “mucin” is intended to denote a highly glycosylated protein forming part of the composition of numerous muci. The mucins are, in particular, characterized by the tandem repetition of amino acid sequences rich in serine and threonine, which are points of attachment for the glycosylated structures.

Mucin-type proteins exist in virtually all animals and many microorganisms. Mucins suitable for the invention are mucins capable of forming a hydrogel.

Mucins suitable for the invention are highly glycosylated, multi-domain proteins whose structure confers upon them the property of forming gels by homo-oligomerization that contributes to the creation of protein networks.

As examples of mucins suitable for the invention, mention may be made of human mucins such as MUC2, MUC5AC, MUC5B, MUC6 or MUC19, or the mucins of fish of the family Myxinidae.

According to one embodiment, glycosylated proteins suitable for the invention may be mucins of fish of the family Myxinidae, for example of Myxine glutinosa.

The mucins may be extracted from natural sources or be produced recombinantly in fermenters using recombinant microorganisms genetically modified to produce the mucin proteins.

By way of example, mucins can be obtained recombinantly according to the process described by Shurer et al. (Biotechnol Bioeng. 2019; 116 (6): 1292-1303.DOI: 10.1002/bit.26940) or in applications US 2012/0165272 A1, or US 2021/0246176 A1.

By way of example, mucins can be prepared from the mucus or hydrogel produced by fish of the family Myxinidae, such as the hagfish.

The mucins of fish of the family Myxinidae, such as the hagfish, can be composed of about 80% proteins and 20% sugars. They can oligomerize by formation of disulfide bridges and sulfonated structures.

### Preparation of a Material Comprising Amyloid Fibers and Glycosylated Proteins

A material activatable according to an electrochemical activation process described herein and comprising hydronium ion-conducting amyloid fibers and glycosylated proteins may be obtained by any method known in the field.

Such a material may be obtained by synthetic routes, by biotechnological processes that make it possible to obtain hydronium ion-conducting amyloid fibers and recombinant glycosylated proteins, or from animals that produce such materials.

The recombinant proteins may be obtained by heterologous expression in a host cell, for example Escherichia coli or CHO cells, and amplification of the host cells in a bio-incubator. The recombinant proteins thus obtained are then purified by any method known in the field.

According to one embodiment, a material comprising hydronium ion-conducting amyloid fibers and glycosylated proteins may be obtained from a hydrogel produced by a fish selected from fish of the family Myxinidae, and in particular from the subfamilies Myxininae and Eptatretinae.

According to one embodiment, a material activatable by an electrochemical process and suitable for the invention may be prepared from a mucus or hydrogel secreted by a fish selected from fish of the family Myxinidae, and in particular from the subfamilies Myxininge and Eptatretinae. The fish may be selected from fish of the genus Myxine, Nemamyxine, Neomyxine, Notomyxine, Eptatretus, Heptatretus or Rubicundus.

A material suitable for the invention may be obtained from a fish selected from Myxine affinis, Myxine australis, Myxine capensis, Myxine circifrons, Myxine debueni, Myxine dorsum, Myxine fernholmi, Myxine formosana, Myxine garmani, Myxine glutinosa, Myxine hubbsi, Myxine hubbsoides, Myxine ios, Myxine jespersenae, Myxine knappi, Myxine kuoi, Myxine limosa, Myxine mccoskeri, Myxine mcmillanae, Myxine paucidens, Myxine pequenoi, Myxine robinsorum, Myxine sotoi, Eptatretus bischoffii, Eptatretus burgeri, Eptatretus caribbeaus, Eptatretus carlhubbsi, Eptatretus chinensis, Eptatretus cirrhatus, Eptatretus deani, Eptatretus decatrema, Eptatretus eos, Eptatretus fernholmi, Eptatretus fritzi, Eptatretus goliath, Eptatretus grouseri, Eptatretus hexatrema, Eptatretus indrambaryai, Eptatretus lakeside, Eptatretus laurahubbsae, Eptatretus longipinnis, Eptatretus mcconnaugheyi, Eptatretus mccoskeri, Eptatretus mendozai, Eptatretus menezesi, Eptatretus minor, Eptatretus multidens, Eptatretus nanii, Eptatretus octatrema, Eptatretus okinoseanus, Eptatretus polytrema, Eptatretus profundus, Eptatretus sinus, Eptatretus springeri, Eptatretus stoutii, Eptatretus strahani, Eptatretus wayuu, and Eptatretus wisneri.

According to one embodiment, a material suitable for the invention may be obtained from the fish Myxine glutinosa.

According to one embodiment, a material suitable for the invention may be prepared from a hydrogel comprising amyloid fibers and glycosylated proteins, for example from a mucus or hydrogel obtained from a fish of the family Myxinidae.

According to one embodiment, a hydrogel obtained from a fish of the family Myxinidae may be subjected to a step of mechanical deformation, in particular stretching, in order to enable the conversion of the a helices of the proteins of the intermediate filaments into sheets. This step may be carried out mechanically or manually, for example by manipulating the hydrogel during its removal from a fish of the family Myxinidae or by using a device making it possible to stretch the hydrogel.

A mechanical deformation process suitable for converting the a helices of the proteins of the intermediate filaments into β sheets may comprise a stretching step.

The stretching may be achieved by manual pulling.

Alternatively, the stretching may be obtained by means of a mechanical device, for example an extruder, a carder or a loom.

The stretching force enabling the conversion of the a helices of the proteins of the intermediate filaments into β sheets is adapted by those skilled in the art so as to obtain the desired conversion without breaking the material. The conversion of the a helices into β sheets may be determined by any method known in the field, for example as described by Litvinov et al. (Biophys J. 2012; 103(5): 1020-1027) or Fudge et al. (Biophys J. 2003; 85(3): 2015-2027).

A stretching force suitable for converting the a helices of the proteins of the intermediate filaments into β sheets may be at least about 1 MPa, in particular at least 10 MPa, or even at least 20 MPa. According to one embodiment, a stretching force may be in the range of from about 10 to about 20 MPa.

The mechanical deformation step may be exerted on a dehydrated material.

A material suitable for the invention may comprise glycosylated proteins, for example mucins, for example mucins obtained from fish of the family Myxinidae, and amyloid fibers, for example in the form of intermediate filaments, for example obtained from fish of the family Myxinidae. The intermediate filaments are stretched.

According to one embodiment, a material suitable for the invention may be in the form of a fiber, a thread or a film. A material suitable for the invention may be in the form of a film. A material suitable for the invention may be in the form of a thread.

According to one embodiment, a material suitable for the invention may be dehydrated.

According to one embodiment, a hydrogel or mucus comprising amyloid fibers and glycosylated proteins which is used to prepare a material suitable for the invention is subjected to a dehydration step. This dehydration step may be carried out by any method known in the field.

The dehydration step may be prior to or subsequent to the electrochemical activation step. For example, the dehydration step is prior to the electrochemical activation step.

The conditions of temperature and duration are selected so as to enable the evaporation of the water contained in the hydrogel or mucus without degrading the amyloid fibers and glycosylated proteins.

A hydrogel or mucus comprising amyloid fibers and glycosylated proteins may be arranged in the form of a film, a membrane, fibers or threads.

According to one embodiment, after collection from a fish of the family Myxinidae, a hydrogel may be formed into a membrane by “membrane casting” or into threads by extrusion. Just after collection, a hydrogel has not yet released much water and has a transparent appearance.

According to another embodiment, after partial drying of a hydrogel obtained from a fish of the family Myxinidae, the hydrogel may be formed into sheets by spreading and drying. Partial drying can be achieved by simply releasing a significant proportion of water. A hydrogel that has begun to dry also begins to whiten.

Alternatively, a material activatable by a process described herein and prepared from a hydrogel or mucus comprising hydronium ion-conducting amyloid fibers and glycosylated proteins may be arranged in the form of a film, fibers or threads subsequently to the dehydration step.

A hydrogel comprising amyloid fibers and glycosylated proteins, for example a hydrogel obtained from a fish of the family Myxinidae, for example Myxine glutinosa, may be dehydrated by any method known in the field as described above.

According to one embodiment, a film of a dehydrated material suitable for a process of the invention may be prepared from a hydrogel comprising amyloid fibers and glycosylated proteins, for example a hydrogel obtained from a fish of the family Myxinidae, for example Myxine glutinosa, spread in a thin layer on a suitable support and exposed to a temperature and for a duration sufficient to reduce the water content of the hydrogel. A hydrogel layer may have a thickness ranging from about 10 to about 900 μm, for example from about 50 to about 600 um, or also for example from about 100 to about 500 μm.

A support suitable for spreading a hydrogel into a film must prevent the adhesion of the hydrogel to the support. Such a support may be hydrophobic.

A support for spreading a hydrogel into a film may be, for example, parchment paper or paper composed of Teflon®.

A dehydration temperature may be from about 40° C. to about 70° C., or from about 45° C. to about 60°° C., or may be about 50° C.

For example, the dehydration of a hydrogel may be carried out in an oven or by exposure to air or to a stream of dry air.

An activated material as described herein may comprise at least one additional electrically conductive material.

An additional electrically conductive material may be a carbon or graphite fiber or wire, a metal fiber or wire, conjugated polymers, or nanoparticles. The metal of a metal fiber or wire may be copper, silver, gold, aluminum, zinc, iron.

An additional electrically conductive material may be combined with a material described herein before or after its activation by an electrochemical activation process described herein.

For example, an additional electrically conductive material may be added to a hydrogel obtained from a hagfish prior to dehydration of the hydrogel. Alternatively, the hagfish hydrogel may be dehydrated and prepared in the form of a film, fibers or threads, and the additional electrically conductive material is added to the film, fibers or fibers.

A material suitable for the invention may be formed into films, fibers or threads.

The forming of a material into a film may be achieved by dehydrating a hydrogel obtained from a fish of the family Myxinidae.

A material may be formed into threads or fibers by any known textile fiber or thread production processes, for example by carding and spinning. The fibers and threads thus obtained may then be used in any process for producing woven or nonwoven fabrics. The weaving operations can make it possible to produce devices that generate electricity from water vapor over large areas. The weaving operations can make it possible to produce films of activated material according to the invention.

The forming of a material into a film, thread or fiber may be carried out before or after activation by a process as described herein.

The forming of a material into a film, thread or fiber may be carried out before or after dehydration of the material obtained in the form of a hydrogel.

An activated material described herein may be manufactured in the form of a woven or nonwoven fabric. An activated material may be prepared in the form of threads or fibers. The threads or fibers obtained may be assembled, for example, into a woven textile or a nonwoven.

When an activated material described herein is prepared in the form of a woven or nonwoven textile, an additional electrically conductive material may be added to the step of assembling the textile.

Any process for preparing woven or nonwoven textiles may be employed.

### Electrochemical Activation Process

According to one of its subjects, the invention relates to a process for electrochemically activating a material comprising amyloid fibers and glycosylated proteins, the process comprising at least the steps consisting in:
(a) bringing at least a part of said material into contact with water vapor,
(b) electrolyzing at least some of the water vapor in contact with said material, and
(c) obtaining an activated material.
Step (b) is carried out by exposing the material to an electrical potential difference.

Without wishing to be bound to a particular theory, the inventors hypothesize that

the electrochemical activation leads to the modification of the intermediate filament proteins and the glycosylated proteins by way of oxidation-reduction reactions of the water vapor which occur during exposure to the electrical potential difference and which induce the creation of a charge gradient. This charge gradient enables an electrical potential difference to be established in the presence of water vapor.

The electrical potential difference can be applied by means of two electrodes electrically connected to the material.

A material activatable by an electrochemical activation process described herein may be brought into contact or attached to the electrodes by any appropriate method known in the field for enabling an electrical connection and the application of an electrical potential difference to the material.

For example, when the material activatable by an electrochemical activation process is prepared from a dehydrated hydrogel of hagfish mucus, it may be attached to the electrodes by simply wetting the region of the material that will be brought into contact with the electrodes.

The electrodes may be disposed so as to each be in contact at a point of the material. A first electrode is in contact with a first point of the material, and a second electrode is in contact with a second point of the material.

For example, the first and/or second electrodes may be selected from gold, silver, platinum, aluminum or carbon electrodes.

The electrical potential difference is capable of inducing electrolysis of at least some of the water vapor in contact with the material. The electrical potential difference may be at least 1.23 V. For example, the electrical potential difference may be in a range from about 1.3 to about 10 V, or from about 1.5 to about 8 V, or from about 2 to about 5 V, or may be about 3 V.

The electrical potential difference may be fixed or variable.

A fixed electrical potential difference is an electrical potential difference which remains substantially constant throughout the duration of the electrochemical activation step. The electrical potential difference is applied at the value selected for achieving the electrolysis of the water and then remains substantially constant during the electrochemical activation step.

A variable electrical potential difference is an electrical potential difference the value of which changes over time during the electrochemical activation step. A variable electrical potential difference includes electrical potential values that enable the electrolysis of the water.

A variable electrical potential difference may extend over a range extending from about 0 to about 10 V, or from about 1.23 to about 10 V, or from about 1.5 to about 8 V, or from about 3 to about 4 V.

For example, a variable electrical potential difference may extend over a range extending from about 1.23 V to about 3 V.

An electrical potential difference, whether fixed or variable, is applied at a value and for a duration sufficient to electrolyze the water vapor in contact with a material described herein and to achieve the electrochemical activation of this material.

The electrochemical activation of the material may be characterized by the capacity of the material thus activated to generate an electric current in the presence of water vapor. Such an electric current may be measurable by chronoamperometry at 0 V vs Eoc.

Chronoamperometry is an electrochemical technique in which the electrical potential of the working electrode is stepped and the current resulting from faradaic processes occurring at the electrode is monitored as a function of time.

The electrochemical activation of the material may also be characterized by any method for measuring the change in chemical structure of a material, such as mass spectrometry for example or analytical chemistry methods.

Step (a) of bringing the material into contact with water vapor may be carried out by placing the material in a humid atmosphere.

A humid surrounding atmosphere for an electrochemical activation process described herein may comprise a relative humidity ranging from about 60% to about 100%, or from about 65% to about 99%, or from about 70% to about 95%, or from about 75% to about 90%, or from about 80% to about 85%, or which is about 85%. A humid surrounding atmosphere for an electrochemical activation process described herein may comprise a relative humidity of at least 60%, or at least 65%, or at least 70%, or at least 75%, or at least 80%, or at least 85%, or at least 90%, or at least 95%, or at least 99%.

According to one embodiment, a humid atmosphere surrounding the material may comprise a relative humidity ranging from at least about 70% to about 90%, and may be, for example, about 85%.

A humid surrounding atmosphere may be obtained by any method known in the field. For example, a humid surrounding atmosphere may be obtained by means of a saturated salt solution, for example of KCl.

The relative humidity of an atmosphere may be measured by any known method, for example by means of a hygrometer.

An atmosphere used in the process described herein may be a neutral atmosphere. A neutral atmosphere is an atmosphere that does not react chemically or physically with the elements in contact with it.

A humid neutral atmosphere is an atmosphere comprising water vapor and a neutral gas that does not react chemically or physically with the elements in contact with it during the performance of the process described herein. In contrast, and in accordance with the process described herein, the water vapor in contact with the material to be electroactivated can undergo electrolysis under the appropriate conditions.

A neutral atmosphere may comprise, as neutral gas, nitrogen, helium, neon, argon or a mixture thereof. According to one embodiment, a neutral atmosphere may comprise, as neutral gas, nitrogen or argon, and for example may comprise nitrogen.

When an electroactivatable material is prepared from a hydrogel, for example a hagfish mucus, the electrochemical activation process may comprise, prior to step (a), a step of dehydrating the hydrogel.

The hydrogel dehydration step may be carried out by any method known in the field, for example as detailed above. One method that can be used may be the exposure of the material to a temperature and for a duration sufficient to enable the evaporation of the water contained in the hydrogel.

When an electroactivatable material is prepared from a hydrogel comprising intermediate filaments, for example a hagfish mucus, the electrochemical activation process may comprise, prior to the hydrogel dehydration step, a step of mechanically deforming, for example stretching, the hydrogel in order to achieve a conversion of all or some of the a helices into β sheets.

According to one embodiment, a process for preparing a material activated by electrochemical activation, the material comprising glycosylated proteins and intermediate filaments, may comprise at least the steps consisting in:
(i) obtaining a material to be activated in the form of a hydrogel comprising glycosylated proteins and intermediate filaments, the intermediate filaments comprising proteins comprising a helices,
(ii) mechanically deforming the material obtained in step (i), for example by stretching, in order to achieve a conversion of at least some of the a helices of the proteins of the intermediate filaments into β sheets (amyloid fibers),
(iii) at least partially dehydrating the material obtained in step (ii),
(iv) bringing at least a part of the material obtained in step (iii) into contact with water vapor,
(v) electrolyzing at least some of the water vapor in contact with said material, and
(vi) obtaining an activated material.

According to one embodiment, a process for preparing a material activated by electrochemical activation,
the material being in the form of a hydrogel comprising glycosylated proteins and intermediate filaments, the intermediate filaments comprising proteins comprising β sheets (amyloid fibers) obtained from all or part of the conversion of the a helices of said proteins,
and the process comprising at least the steps consisting in:
(i) at least partially dehydrating the material,
(ii) bringing at least a part of the material obtained in step (i) into contact with water vapor,
(iii) electrolyzing at least some of the water vapor in contact with said material, and
iv) obtaining an activated material.

An activated material obtained on conclusion of an electrochemical activation process described herein is capable of generating an electric current by being brought into contact with water vapor.

An activated material obtained on conclusion of an electrochemical activation process described herein is a conductor of hydronium ions.

### Uses of an Activated Material

An activated material, comprising hydronium ion-conducting amyloid fibers and glycosylated proteins, as described herein, may be used to generate electrical energy by contact with a humid surrounding atmosphere.

In such a use, the material may be electrically connected to a first electrode and to a second electrode. The pair of electrodes may be disposed on the surface of materials of varied natures and forms. The choice of the nature and form of the materials intended to support the electrodes is adjusted by those skilled in the art according to the use to be made of the electrodes. As materials that can be used, mention may be made of plastic resins or polymers, vitreous materials, or fabrics.

The first and/or second electrodes may be selected from gold, silver, platinum, aluminum or carbon electrodes.

An activated material, for example in the form of a thread, fiber or film, may be electrically connected to a first electrode and to a second electrode. The first electrode is electrically connected, for example via a tip of this electrode, to a first point of the material, and the second electrode is electrically connected, for example via a tip of this electrode, to a second point of the material. The first and second electrodes may form a pair of electrodes.

A thread or fiber of activated material may comprise a first end and a second end. According to one embodiment, a first electrode may be electrically connected, for example via a tip, to a first end of the thread or fiber, and a second electrode may be electrically connected, for example via a tip, to a second end of said thread or fiber.

An activated material, as described herein, may be used in a device for producing electrical energy.

A device for producing electrical energy may comprise:
(a) at least one activated material as described herein,
(b) at least one pair of electrodes comprising a first electrode and a second electrode, said electrodes being electrically connected to said material,
said material being intended to be exposed (brought into contact), at least partially, to (with) a humid surrounding atmosphere.

The amount of electrical energy generated by a device as described herein may depend on the humidity content of the surrounding atmosphere in contact with the activated material. Similarly, the amount may depend on the surface area of the film or on the number of fibers or threads present in a device.

According to one embodiment, a device as described may comprise an activated material in the form of threads. The threads may be woven or not woven.

According to one embodiment, a device as described may comprise a plurality of threads or films each electrically connected to a first electrode and to a second electrode.

According to one embodiment, a device may comprise a plurality of threads or films arranged in parallel.

According to another embodiment, a device may comprise a plurality of threads or films arranged in series.

According to an embodiment variant, a device as described herein may comprise a plurality of pairs of first and second electrodes, each of said pairs of electrodes being electrically connected to a thread or to a film, or to a plurality of, at least 2, 3, 4, 5, 6, 7, 8, 9, 10, 20, 30, 40, 50, 60, 70, 80, 90, 100, 200, 500, 1000, or more, threads or films. In such an embodiment, the threads or films are then electrically connected in parallel.

A device as described herein may comprise a plurality of pairs of first and second electrodes. These pairs of electrodes may be electrically connected to each other in series or in parallel.

According to an embodiment variant, a device as described herein may comprise a pair of first and second electrodes, or a plurality of, at least 2, 3, 4, 5, 6, 7, 8, 9, 10, 20, 30, 40, 50, 60, 70, 80, 90, 100, 200, 500, 1000, or more, pairs of first and second electrodes, each pair of first and second electrodes being electrically connected to a thread or film, or a plurality of threads or films, at least 2, 3, 4, 5, 6, 7, 8, 9, 10, 20, 30, 40, 50, 60, 70, 80, 90, 100, 200, 500, 1000, or more, as described herein. When at least two or more pairs of electrodes are present, the latter may be electrically connected to each other in series or in parallel.

A parallel architecture advantageously enables a reduction in the internal resistance.

A series architecture advantageously enables an increase in the charging electrical potential of the circuit to several volts. In addition, a series architecture makes it possible to have a high internal resistance and to be able to design and produce, to order, a device with a well-defined final resistance.

According to one embodiment, a device may comprise a plurality of threads or films arranged in parallel and a plurality of threads or films arranged in series.

According to one embodiment, a device may include a plurality of pairs of electrodes electrically connected to one or to a plurality of threads or films and arranged in parallel and a plurality of pairs of electrodes electrically connected to one or to a plurality of threads or films and arranged in series.

The plurality of threads or of pairs of electrodes may be arranged so as to form a planar, two-dimensional configuration, or a three-dimensional configuration.

According to one embodiment, a device comprises at least one film, fiber or at least one thread of an activated material arranged such that at least 50%, for example at least 60%, at least 70%, at least 80%, at least 90% or even 100% of the surface of the film or of the length of the fiber or thread is exposed to the humid surrounding atmosphere.

A device as described herein may be a device for providing electrical energy, for example a battery.

A device for producing electrical energy described herein may be used to supply electrical energy to an electrical or electronic apparatus intended to be supplied with electrical energy.

A device for producing electrical energy described herein may be used in a process for supplying electrical energy to an electrical or electronic apparatus.

A process for supplying electrical energy to an electrical or electronic apparatus intended, or configured, to be supplied with electrical energy may comprise at least a step consisting in exposing, to a humid surrounding atmosphere, at least partially, at least one activated material as described herein, said material being disposed in a device for producing electrical energy as described herein, said device being electrically connected to said electrical or electronic apparatus.

According to another embodiment, the present disclosure relates to a process for supplying electrical energy to an electrical or electronic apparatus intended to be supplied with electrical energy, the process comprising at least the steps consisting in:
a) electrically connecting a device as described to an electrical or electronic apparatus intended to be supplied with electrical energy, and
b) exposing, at least partially, the activated material to a humid surrounding atmosphere.

A device for producing electrical energy described herein may be prepared by a manufacturing process comprising at least one step consisting in disposing an activated material as described herein between a first electrode and a second electrode of a pair of electrodes in order to electrically connect said electrodes to said material.

A device as described herein may be prepared by a process further comprising at least the steps consisting in:
bringing a material activatable by an electrochemical activation process, the material comprising hydronium ion-conducting amyloid fibers and glycosylated proteins, into contact with a first electrode and a second electrode of a pair of electrodes in order to electrically connect said electrodes to the material, and
bringing at least a part of said material into contact with water vapor,
electrolyzing at least some of the water vapor in contact with said material, and
obtaining an activated material.

A device as described herein may be prepared with a material in the form of a hydrogel comprising glycosylated proteins and intermediate filaments, the intermediate filaments comprising proteins comprising β sheets obtained from all or part of the conversion of the a helices of said proteins, and by a process further comprising at least the steps consisting in:
electrically connecting said material to a first electrode and a second electrode of a pair of electrodes,
at least partially dehydrating the material, and
bringing at least a part of the material obtained in the preceding step into contact with water vapor,
electrolyzing at least some of the water vapor in contact with said material.

A device as described herein may be prepared by a process further comprising at least the steps consisting in:
obtaining a material in the form of a hydrogel comprising glycosylated proteins and intermediate filaments, the intermediate filaments comprising proteins comprising β sheets obtained from all or part of the conversion of the a helices of said proteins,
electrically connecting said material to a first electrode and a second electrode of a pair of electrodes,
at least partially dehydrating the material, and
bringing at least a part of the material obtained in the preceding step into contact with water vapor,
electrolyzing at least some of the water vapor in contact with said material. The material may be in the form of films, threads or fibers.

A device described herein may advantageously be used in a zone of high humidity, for example a marine environment, for recharging small electrical or electronic apparatuses, of smartphone, sensor, for example humidity sensor, beacon, electric charger, or lamp type.

A device for producing electrical energy described herein may be installed in a humidity sensor, a humidity-responsive electrical circuit breaker, or an electrical charger.

It is understood that the present description encompasses all variations, combinations and permutations in which at least one limitation, element, clause, descriptive term, etc., of at least one of the claims is introduced into another claim dependent on the same base claim (or, if applicable, into any other claim), unless indicated otherwise or when it is obvious to a person skilled in the art that a contradiction or inconsistency would occur. Where elements are presented in the form of lists, for example in a Markush group or in a similar form, it is understood that each sub-group of elements is also disclosed and that any element may be removed from the group. It should be understood that, in general, where the disclosure, or aspects of the disclosure, is/are designated as comprising particular elements, features, etc., they also encompass embodiments consisting of, or essentially consisting of, such elements, features, etc. For the sake of simplicity and concision, these elements have not always been specifically set out in the present document. It should also be understood that any embodiment or aspect of the disclosure may be explicitly excluded from the claims, whether or not the specific exclusion is mentioned in the description. The publications and other reference documents mentioned in the description in order to describe the context of the invention and to provide additional details concerning its implementation are incorporated by reference.

Without limiting the present description of the invention, various embodiments of the invention are described hereinafter for illustrative purposes.

### EXAMPLES

### Example 1: Preparation of a Film of Electroactivatable Material

A film of hydronium ion-conducting amyloid fibers and glycosylated proteins was produced from a hydrogel, secreted by hagfish (Myxine glutinosa), by dehydration. The hydrogel secreted by the hagfish is composed of mucins, glycosylated proteins, and intermediate filaments. During the manipulation of the hydrogel, the intermediate filaments are stretched, and at least some of the proteins constituting them undergo a transition from their a helices to β sheets, conferring upon the intermediate filaments a structure and properties of amyloid fibers. These amyloid fibers are in particular conductors of hydronium ions.

The hydrogel was isolated directly after capture of the hagfish. It was spread over parchment paper disposed on a grid. Placing in an oven until complete drying at a temperature of 50° C. made it possible to obtain by dehydration a film of mucins and intermediate filament proteins in the form of a sheet.

Example 2: Electrochemical Activation of the Material Comprising Glycosylated Proteins and Amyloid Fibers

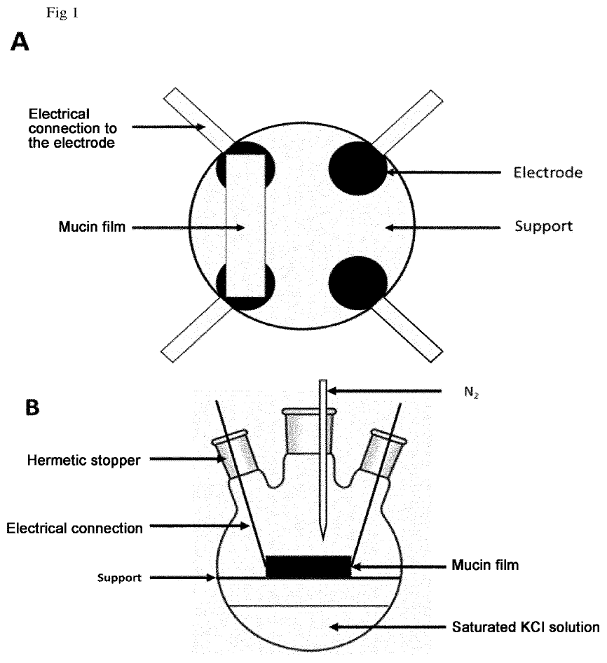

A piece of film of glycosylated proteins and amyloid fibers, i.e. mucins and intermediate filament proteins, (1 cm×2 mm) was connected to two glassy carbon electrodes (diameter: 6 mm). The connection between the film and the glassy carbon was made by wetting the film at the contact points. A 1 mm gap separates the two glassy carbon electrodes (FIG. 1 (A)). This device is then placed in a hermetic chamber. A saturated KCl solution is placed in the hermetic chamber in order to maintain a relative humidity (RH) of 85% (FIG. 1 (B)). The protein film is placed in the climatic chamber at high humidity (85%) and the chamber was degassed with nitrogen (N₂) for 18 h.

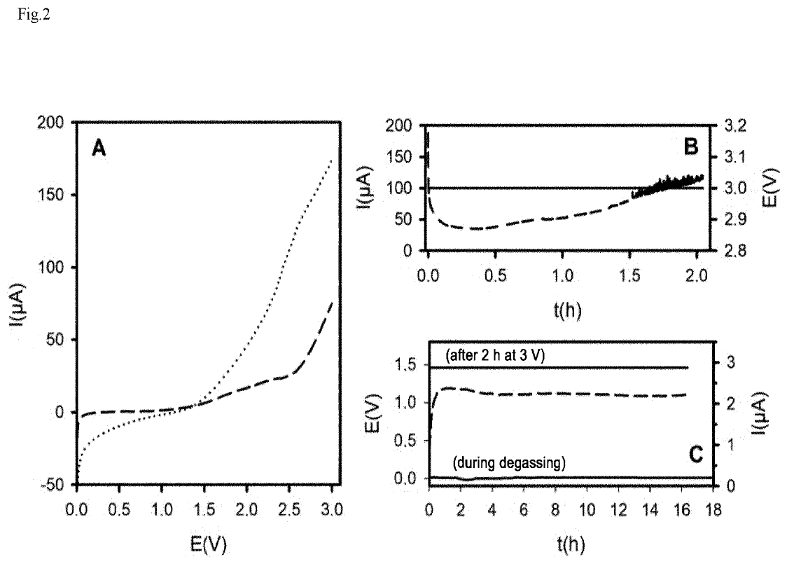

The open-circuit electrical potential difference (E_{OC}) between the two electrodes was recorded during the degassing (FIG. 2 (C)).

It can be seen that the Eoc observed during the degassing is unstable during the first 7 hours. Thereafter, stabilization can be seen at around 10 mV.

Once the degassing was completed, a first current-potential (I-V) curve was produced between 0 and 3 V at a rate of 5 mV/s (FIG. 2 (A), dashed line). This curve can be broken down into 3 phases:
Phase 1: between 0 V and 1.4 V, a very low current is observed,
Phase 2: between 1.4 V and 2.6 V, a slight increase in current is observed, which corresponds to the beginning of electrolysis of the water which occurs starting from 1.23 V,
Phase 3: between 2.6 V and 3 V, an increase in the current up to 80 μA, which corresponds to the electrolysis of water since the electrical potential is greater than 1.23 V.

Chronoamperometry at 3 V vs E_{ref} was then carried out for 2 h in order to observe the evolution of the current as a function of time (FIG. 2 (B)). It can be seen first of all that there is a decrease in the current during the first few minutes. This corresponds to the stabilization of the system following the I-V curve produced previously. Subsequently, there is an increase in the current over time since it goes from 40 μA to 120 μA. During this step, the oxidation of the water takes place on the anode side and the reduction of the protons to hydrogen takes place on the cathode side.

A further chronoamperometry measurement was then carried out at 0 V vs E_{oc} (FIG. 2 (C)). The current and the E_{oc} were recorded.

The current observed is stable at 2.5 μA, which is in agreement with the values obtained with the I-V. Moreover, it is clearly apparent that an electrical potential difference has become established at 1.46 V and is stable over a period of 16 h.

A second I-V curve between 0 V and 3 V at a rate of 5 mV/s was then produced (FIG. 2 (A), dotted line). It can be seen that the current values are higher than the values observed during the first I-V. There has therefore been electrochemical activation of the hagfish film.

Without wishing to be held to a specific mechanism, the inventors hypothesize that the electroactivation results from modifications of the proteins due to oxidation-reduction reactions occurring on either side of the film during the exposure to an electrical potential difference of 3 V and having induced the creation of a charge gradient in the film enabling the establishment of an electrical potential difference in the presence of water vapor. A mechanism of this nature has been used to modify the distribution of charges in graphene sheets and thus to generate electricity from water vapor (Wang et al., J. Mater. Chem. A9, 8870-8895, 2021).

### Example 3: Production of energy by an activated film of hydronium ion-conducting amyloid fibers and glycosylated proteins from ambient humidity

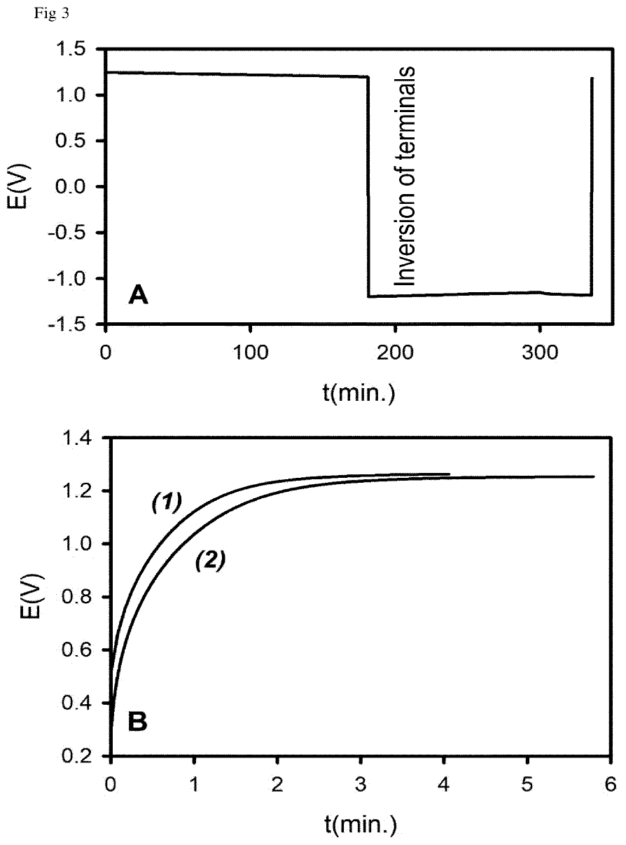

The open circuit electrical potential was then recorded as a function of time (FIG. 3 (A)). It is noted that the Eoc is stable at 1.30 V for several hours. During this experiment, the connections at the terminals of the glassy carbon electrodes were reversed. It can be noted that the Eoc becomes negative (−1.30 V), which indicates that the film of mucins and intermediate filament proteins is naturally polarized in the presence of humidity. The direction of polarization can be attributed to polarizations performed at the beginning of the experiment (I-V and chronoamperometry).

A chemical capacitor was connected to the terminals of the glassy carbon electrodes in order to charge it by virtue of the Eoc (FIG. 3 (B)). The capacitor used is of capacitance 470 μF and 16 V. The capacitor was charged twice, with the Eoc being recorded between the two charges. The latter was in accordance with what was observed previously since the voltage obtained was 1.25 V. Between the two charging tests, the capacitor was discharged over a resistor until a voltage of zero was obtained. It can be seen that the charging kinetics followed by the evolution of the voltage at the terminals of the capacitor does not start at 0 V. This is directly related to the implementation of the experiment and a very low observed charging time constant (τ=RC=40 s). This is because a few seconds had elapsed between the moment when the capacitor was connected to the terminals of the mucin film and the beginning of recording. A limit voltage of 1.25 V was reached after 2 min during the first charge and 3 min during the second charge. This limit voltage corresponded well to the Eoc observed for the hagfish film. The determination of the charging time constant t of the capacitor gave a value of 40 s. If it is considered that a capacitor is charged after 4 τ, a value of 4 and 5 min is indeed found. Finally, from the charging constant, an internal resistance of the film of the order of 50 kΩ can be determined.

These results demonstrate the proof of concept that activated films of glycosylated proteins and amyloid fibers, for example of mucins and intermediate filament proteins prepared from a hydrogel obtained from fish such as hagfish, are capable of recharging a capacitor in the presence of humidity.

Here, the experiments were carried out at a relative humidity (RH) of 85% a quick and easy operation. It is of course conceivable to work at a lower humidity (40%).

It can be seen that the charging time of the capacitor is very short, this being due to the internal resistance of the film. It is conceivable to develop an architecture comprising several films with a mixture of films placed in parallel and in series in order to increase the charging electrical potential (several volts).

### Example 4: Power Curve and Discharge Curve Obtained with a Hagfish Mucus Film

An electrochemically activated hagfish mucus film was prepared as described above. The film was placed in a humid atmosphere (85% RH), and connected to a resistance decade box which makes it possible to vary the load resistance over several orders of magnitude. The potential (V) across the terminals of the resistor is measured with a voltmeter. The intensity of the current (μA) is obtained with the formula I=V/R, and the electric power (μW) with the formula P=V×I.

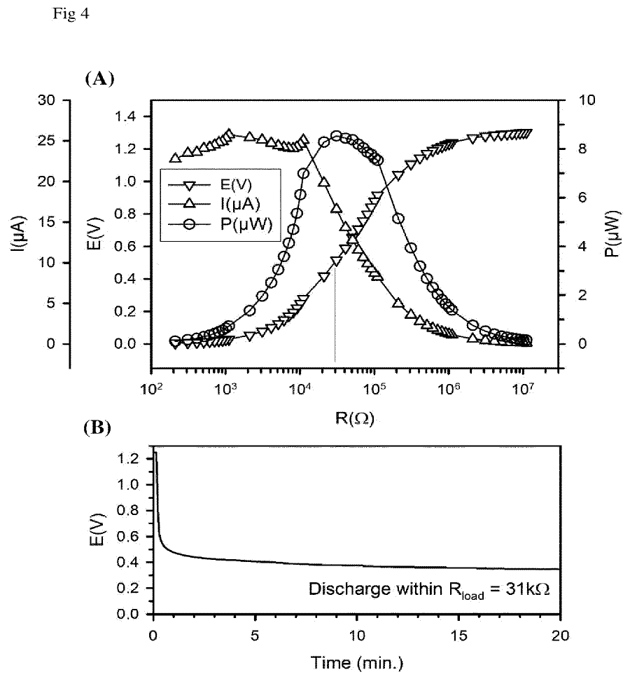

A power curve was obtained for an electrochemically activated hagfish mucus film ([FIG. 4], panel (A)).

The curve shows that a 31 kΩ resistor is the load making it possible to deliver the maximum power.

An electrochemically activated hagfish mucus film was prepared as described above. The film was placed in a humid atmosphere (85% RH), and connected to a 31 kΩ resistor. A voltmeter makes it possible to monitor the evolution of the potential with time.

A discharge curve into a 31 kilohm resistor was obtained which corresponds to the load making it possible to deliver the maximum power ([FIG. 4], panel (B)).

### LIST OF CITED DOCUMENTS

Böcker L., Rühs P. A., Böni L., Fischer P., and Kuster S., “Fiber-Enforced Hydrogels: Hagfish Slime Stabilized with Biopolymers including κ-Carrageenan,” ACS Biomater. Sci. Eng., vol. 2, no. 1, pp. 90-95, 2016, doi: 10.1021/acsbiomaterials.500404.
Böbi L, Fischer P, Böcker L, Kuster S, Rühs P A. Hagfish slime and mucin flow properties and their implications for defense. Sci Rep. 2016;6:30371. Published 2016 Jul. 27. doi:10.1038/srep30371
Böni L J, Sanchez-Ferrer A, Widmer M, et al. Structure and Nanomechanics of Dry and Hydrated Intermediate Filament Films and Fibers Produced from Hagfish Slime Fibers. ACS Appl Mater Interfaces. 2018;10 (47):40460-40473. doi: 10.1021/acsami.8b17166
Fu J, Guerette P A, Miserez A. Self-Assembly of Recombinant Hagfish Thread Keratins Amenable to a Strain-Induced α-Helix to β-Sheet Transition. Biomacromolecules. 2015;16(8):2327-2339. DOI:10.1021/acs.biomac.5b00552
Fudge D S, Gardner K H, Forsyth V T, Riekel C, Gosline J M. The mechanical properties of hydrated intermediate filaments: insights from hagfish slime threads. Biophys J. 2003;85 (3): 2015-2027. DOI: 10.1016/S0006-3495(03)74629-3
Litvinov R I, Faizullin D A, Zuev Y F, Weisel J W. The α-helix to β-sheet transition in stretched and compressed hydrated fibrin clots. Biophys J. 2012;103(5):1020-1027 . DOI:10.1016/j.bpj.2012.07.046
Oliveira P E, Chen D, Bell B E, et al. The next generation of protein super-fibres: robust recombinant production and recovery of hagfish intermediate filament proteins with fibre spinning and mechanical-structural characterizations. Microb Biotechnol. 2021;14 (5):1976-1989. doi:10.1111/1751-7915.13869
Shurer C R, Wang Y, Feeney E, et al. Stable recombinant production of codon-scrambled lubricin and mucin in human cells. Biotechnol Bioeng. 2019;116 (6):1292-1303.doi:10.1002/bit.26940
Stephens, G., Li, J., Wild, M. et al. An update on Earth's energy balance in light of the latest global observations. Nature Geosci 5, 691-696 (2012) https://doi.org/10:1038/ngeo1580
Tang, Q., Duan, Y., He, B., and Chen, H. (2016). Platinum Alloy Tailored All-Weather Solar Cells for Energy Harvesting from Sun and Rain. Angew. Chem. Int. Ed. 55, 14412-14416
US 2005/0034280 A1—Alpha-helical protein based materials and methods for making same
US 2012/0165272 A1—Tear Substitutes
US 2019/0002529 A1—Assembly of Intermediate Filament Proteins in to Filamentous Materials
US 2021/0246176 A1—Mucin-Binding Fusion Proteins
Wang K. and Li J., “Electricity generation from the interaction of liquid-solid interface: a review,” J. Mater. Chem. A9, 8870-8895, 2021, doi.org/10.1039/DOTA12073A
Yang, S., Su, Y., Xu, Y., Wu, Q., Zhang, Y., Raschke, M. B., Ren, M., Chen, Y., Wang, J., Guo, W., et al. (2018). Mechanism of Electric Power Generation from Ionic Droplet Motion on Polymer Supported Graphene, J. Am. Chem. Soc. 140, 13746-13752.
Yin, J., Zhang, Z., Li, X., Yu, J., Zhou, J., Chen, Y., and Guo, W. (2014). Waving potential in graphene. Nat. Commun. 5, 3582.

Zhang, Z., Li, X., Yin, J. et al. Emerging hydrovoltaic technology. Nature Nanotech 13, 1109-1119 (2018). https://doi.org/10.1038/s41565-018-0228-6

1. A process for preparing a material activated by electrochemical activation, said material comprising hydronium ion-conducting amyloid fibers and glycosylated proteins, said process comprising at least the steps consisting in:
(a) bringing at least a part of said material into contact with water vapor,
(b) electrolyzing at least some of the water vapor in contact with said material, and
(c) obtaining an activated material.

2. The process as claimed in claim 1, wherein the water vapor originates from a humid and neutral atmosphere.

3. The process as claimed in claim 2, wherein the humid atmosphere comprises a relative humidity ranging from at least 60% to 100%.

4. The process as claimed in claim 1, wherein the hydronium ion-conducting amyloid fibers are obtained from intermediate filaments.

5. The process as claimed in claim 1, wherein the glycosylated proteins are mucins.

6. The process as claimed in claim 1, wherein the material is obtained from a hydrogel produced by a fish selected from fish of the family Myxinidae, in particular from a hydrogel produced by Myxine glutinosa.

7. An activated material comprising hydronium ion-conducting amyloid fibers and glycosylated proteins and being activated by an electrochemical activation process.

8. The use of an activated material obtained by the process as claimed in claim 1, for generating electrical energy from a humid surrounding atmosphere.

9. A device for producing electrical energy, comprising:
(a) at least one activated material obtained by the process as claimed in claim 1, and
(b) at least one pair of electrodes comprising a first electrode and a second electrode, said electrodes being electrically connected to said material,
said material being intended to be exposed, at least partially, to a humid surrounding atmosphere.

10. A humidity sensor, humidity-responsive electrical circuit breaker, or electrical charger comprising at least one device as claimed in claim 9.
